(19) United States
(12) Patent Application Publication
(10) Pub. No.: US 2019/0284862 A1
(43) Pub. Date: Sep. 19, 2019

(54) LINEAR UNIT

(71) Applicant: Brose Fahrzeugteile GmbH & Co. Kommanditgesellschaft, Bamberg, Bamberg (DE)

(72) Inventors: Michael Buchheim, Bamberg (DE); Uwe Fischer, Sonneberg (DE); Daniel Schnapp, Ebensfeld (DE); Nadja Rehm, Coburg (DE)

(21) Appl. No.: 16/348,060

(22) PCT Filed: Nov. 6, 2017
(86) PCT No.: PCT/EP2017/078349

§ 371 Date: May 7, 2019

(30) Foreign Application Priority Data
Nov. 8, 2016 (DE) 10 2016 121 350.0

(51) Int. Cl. E05F 15/622; F16H 25/20; F16H 25/24; F16F 3/04

(52) U.S. Cl. CPC E05F 15/622; F16H 25/2021; E05Y 2201/474; F16F 3/04; E05Y 2900/546; F16H 25/2454

(57) ABSTRACT

The disclosure relates to a linear unit for a flap arrangement with a flap, and a closed position, wherein the linear unit has two drive connections which are coupled to each other via a gearing and are adjustable relative to each other along a geometrical linear axis, wherein the linear unit has a helical spring arrangement, wherein the helical spring arrangement has a first spring element which is configured as a helical spring and a second spring element which is configured as a helical spring, with which helical springs the two drive connections can be pretensioned against each other, wherein the second spring element is oriented coaxially with respect to the first spring element with regard to a geometrical spring axis. It is proposed that the spring wire at one end of the second spring element forms a supporting portion via which the first spring element secures the second spring element axially.

### CROSS-REFERENCE TO RELATED APPLICATIONS

This application is a national stage application under 35 U.S.C. 371 of International Patent Application Serial No. PCT/EP2017/078349, entitled “Linear Unit,” filed Nov. 6, 2017, which claims priority from German Patent Application No. DE 10 2016 121 350.0, filed Nov. 8, 2016, the disclosure of which is incorporated herein by reference.

### FIELD OF THE TECHNOLOGY

The disclosure relates to a linear unit for a flap arrangement.

### BACKGROUND

The term “flap” or “flap arrangement” should be understood broadly here. A flap comprises, for example, a tailgate, a rear cover, an engine bonnet, a side door, a loading compartment flap, a lifting roof or the like of a motor vehicle. Correspondingly, the term “flap arrangement” comprises, for example, a tailgate arrangement, a rear cover arrangement, an engine bonnet arrangement, a side door arrangement, a loading compartment flap arrangement, a lifting roof arrangement or the like. However, this should not be understood as limiting. The field of use of the, in particular motorized, adjustment of a tailgate of a motor vehicle is to the fore below.

Linear units have long been known from the prior art. Linear units for a flap arrangement are generally designed as spindle drives. For example, DE 10 2011 122 316 A1 describes a spindle drive which has two drives connections which are coupled to each other via a spindle/spindle-nut gearing and are adjustable relative to each other along a geometrical linear axis by means of a motorized drive. By means of an adjustment along the geometrical linear axis, the flap can be adjusted in motorized manner between an open position and a closed position. Furthermore, the linear unit has a spring element which is configured as a helical spring, pushes the two drive connections apart and thus assists the motorized opening of the flap.

In addition, spindle drives are known which additionally have a further spring element, which is also referred to as a “pop-up spring”. Said pop-up spring is generally considerably shorter than the first spring element and assists the motorized opening of the tailgate only in a partial adjustment range of the flap, generally in a range out of the closed position. The pop-up spring is therefore not permanently braced and therefore also not secured by means of its pretensioning over the entire adjustment range of the flap. The pop-up spring is therefore generally clipped by means of an additional installation step during the installation, in order to keep it in a defined position. However, it has turned out that said clipping from time to time comes loose, as a result of which the pop-up spring is no longer held and can move within the spindle drive. This leads to noticeable acoustic noises during the opening and/or closing of the flap because of movements of the pop-up spring in the interior of the spindle drive.

The disclosure is based on the problem of providing a linear unit for a flap arrangement, which can be fitted in a simple manner and permanently has a low noise behaviour, which is pleasant for the user, during the adjustment of the flap.

### SUMMARY

The above problem is solved in the case of a linear unit according to the disclosure.

Owing to the fact that the linear unit has a helical spring arrangement with a first spring element which is designed as a helical spring and is made from spring wire and a second spring element which is designed as a helical spring and is made from spring wire, wherein the spring wire at one end of the second spring element forms a supporting portion via which the first spring element secures the second spring element axially with regard to the spring axis, the linear unit can be fitted in a particularly simple manner. The spring elements merely have to be plugged into one another. In addition, by securing the second spring element by means of the first spring element, permanently defined securing of the second spring element is achieved. Undesirable acoustic noises which are attributed to a possibly loosened, second spring element no longer occur.

The second spring element can be arranged within the first spring element, thus resulting in an overall compact design.

According to various embodiments, it is proposed that the helical spring arrangement pushes the two drive connections apart, and/or that the two spring elements are each configured as helical compression springs. These are structurally particularly simple configurations in order to permit an opening of the flap that is at least assisted by the spring arrangement.

If the gearing is designed as a spindle/spindle-nut gearing, as proposed in various embodiments, it can be used for converting drive movements along the linear axis. The spindle/spindle-nut gearing can be arranged here within the first spring element.

In particular in combination with a motorized drive, as proposed in some embodiments, the flap arrangement can be adjusted in a motorized manner particularly simply. Particularly, the drive train between the drive connections and the gearing is not configured here to be self-locking. In this case, manual opening and closing of the flap is also made possible without a coupling having to be connected in between.

In some embodiments, it is proposed that in the fitted state, the second spring element acts with its spring pretensioning on the flap, in particular in the opening direction thereof, only over a partial adjustment range of the flap. Particularly, in the fitted state, the second spring element acts with its spring pretensioning on the flap, in particular in the opening direction thereof, only over a partial adjustment range of the flap, which partial adjustment range is limited by the closed position of the flap. The spring element is then an above-discussed pop-up spring. By this means, the opening operation can be assisted in a particular manner especially in an initial adjustment range. In said initial adjustment range, the forces to be applied by the linear unit for opening the flap are particularly large because of the lever ratios effective there.

According to various embodiments, the linear unit can have a receiving surface for receiving the spring arrangement, wherein the supporting portion is secured by axial clamping between the first spring element and the supporting surface. This results in a structurally particularly simple manner of fixing the second spring element. The latter can be securely held in a simple manner and loosening of same is securely prevented. No unpleasant noises due to movements of a possibly loosened second spring element can arise.

The securing of the second spring element can be further improved if, according to various embodiments, the supporting portion has a supporting winding which is secured by axial clamping between the first spring element and the receiving surface, wherein the supporting winding can have a helical or spiral or circular-section profile.

Furthermore, the above problem can be solved by a flap arrangement with at least some of the features disclosed herein. The same advantages as already described above in conjunction with the linear unit arise. The flap arrangement has a linear unit with the described features individually or in combination.

Various embodiments provide a linear unit for a flap arrangement with a flap which is adjustable between an open position and a closed position, wherein the linear unit has two drive connections which are coupled to each other via a gearing and are adjustable relative to each other along a geometrical linear axis, wherein the linear unit has a helical spring arrangement, wherein the helical spring arrangement has a first spring element which is configured as a helical spring and is made from spring wire and a second spring element which is configured as a helical spring and is made from spring wire, with which helical springs the two drive connections can be pretensioned against each other, wherein the second spring element is oriented coaxially with respect to the first spring element with regard to a geometrical spring axis, wherein the spring wire at one end of the second spring element forms a supporting portion via which the first spring element secures the second spring element axially with regard to the spring axis.

In some embodiments, the second spring element is arranged within the first spring element.

In some embodiments, the helical spring arrangement pushes the two drive connections apart, and/or in that the two spring elements are each configured as helical compression springs.

In some embodiments, the gearing has a spindle/spindle-nut gearing, in particular for converting drive movements along the linear axis, such as the spindle/spindle-nut gearing can be arranged within the first spring element.

In some embodiments, the linear unit has a motorized drive for producing drive movements along the linear axis, and in that, when the linear unit is fitted, the flap arrangement is adjustable in a motorized manner by means of the linear unit.

In some embodiments, the drive train between the drive connections and the gearing is not configured to be self-locking.

In some embodiments, the first spring element is otherwise in engagement in a force-fitting manner with the linear unit over the entire adjustment range of the linear unit, and in that the second spring element is otherwise in engagement in a force-fitting manner with the linear unit only over a partial adjustment range, in particular over a partial adjustment range which is located at one end of the entire adjustment range.

In some embodiments, in the fitted state, the second spring element acts with its spring pretensioning on the flap, in particular in the opening direction thereof, only over a partial adjustment range of the flap, such as, in the fitted state, the second spring element can act with its spring pretensioning on the flap, in particular in the opening direction thereof, only over a partial adjustment range of the flap, which partial adjustment range is limited by the closed position of the flap.

In some embodiments, in the fitted state, the second spring element is shorter than the first spring element.

In some embodiments, the linear unit has a receiving surface for receiving the spring arrangement, and in that the supporting portion is secured by axial clamping between the first spring element and the receiving surface.

In some embodiments, the supporting portion has at least one portion of a supporting winding which is secured by axial clamping between the first spring element and the receiving surface, such as the supporting winding can have a helical or spiral or circular-section profile.

In some embodiments, the winding pitch of the supporting portion, in particular of the supporting winding, is lower than the winding pitch of the second spring element otherwise, such as the winding pitch of the supporting element, in particular of the supporting winding, can be smaller than 10°, smaller than 5°, or further is substantially 0°.

In some embodiments, the supporting portion, in particular the supporting winding, extends with regard to the spring axis over an angular range of at least 60°, at least 90°, at least 120°, furthermore at least 180°, or furthermore at least 270°.

In some embodiments, the central winding diameter of the supporting winding of the second spring element is greater than the outer winding diameter of the second spring element otherwise, such as the inner winding diameter of the supporting winding of the second spring element can be greater than the outer winding diameter of the second spring element otherwise.

In some embodiments, for the axial securing, the first spring element acts on the supporting portion, in particular the supporting winding, over an angular range of at least 60°, at least 90°, furthermore at least 120°, furthermore at least 180°, or furthermore at least 270°, with regard to the spring axis.

Various embodiments provide a flap arrangement with a flap which is adjustable between an open position and a closed position, and with a linear unit according to the disclosure which is coupled to the flap in terms of drive.

### BRIEF DESCRIPTION OF THE DRAWINGS

The disclosure is explained in more detail below with reference to a drawing which illustrates merely one exemplary embodiment. In the drawing

FIG. 1 shows an exemplary embodiment of a flap arrangement according to the proposal with a linear unit according to the proposal, and the linear unit in an enlarged, three-dimensional illustration,

FIG. 2 shows an exemplary embodiment of a linear unit according to the proposal in a) an extended state and in b) a retracted state,

FIG. 3 shows an exemplary embodiment of the helical spring arrangement of a linear unit according to the proposal, and

FIG. 4 shows an exemplary embodiment of the helical spring arrangement from FIG. 3 in an exploded illustration.

### DETAILED DESCRIPTION

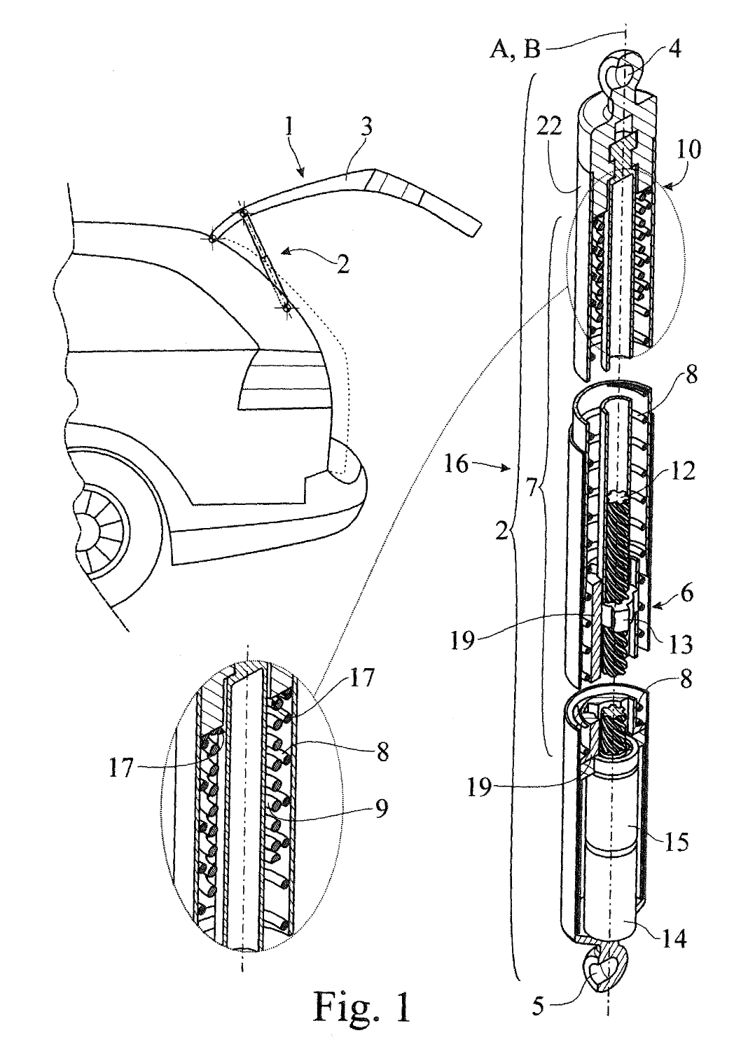

FIG. 1 shows a flap arrangement 1 according to the proposal which is adjustable between an open position and a closed position. With regard to the definition of the terms “flap” and “flap arrangement”, reference is made to the introductory part of the description.

The flap arrangement 1 which is shown has a linear unit 2 according to the proposal which is coupled in terms of drive to the flap 3. Here, the flap arrangement 1 has two linear units 2 according to the proposal. In the exemplary embodiment, said linear units serve for adjusting the flap 3 from a closed position into an, in particular completely opened, open position and/or from an, in particular completely opened, open position into a closed position.

The linear unit 2 according to the proposal has two drive connections 4, 5. The latter serve in particular for introducing a force into the flap 3 for opening and/or for closing same. The drive connections 4, 5 are coupled to each other via a gearing 6 and are adjustable relative to each other along a geometrical linear axis A. The gearing 6 here is designed as a spindle/spindle-nut gearing. It serves here for converting drive movements along the linear axis A.

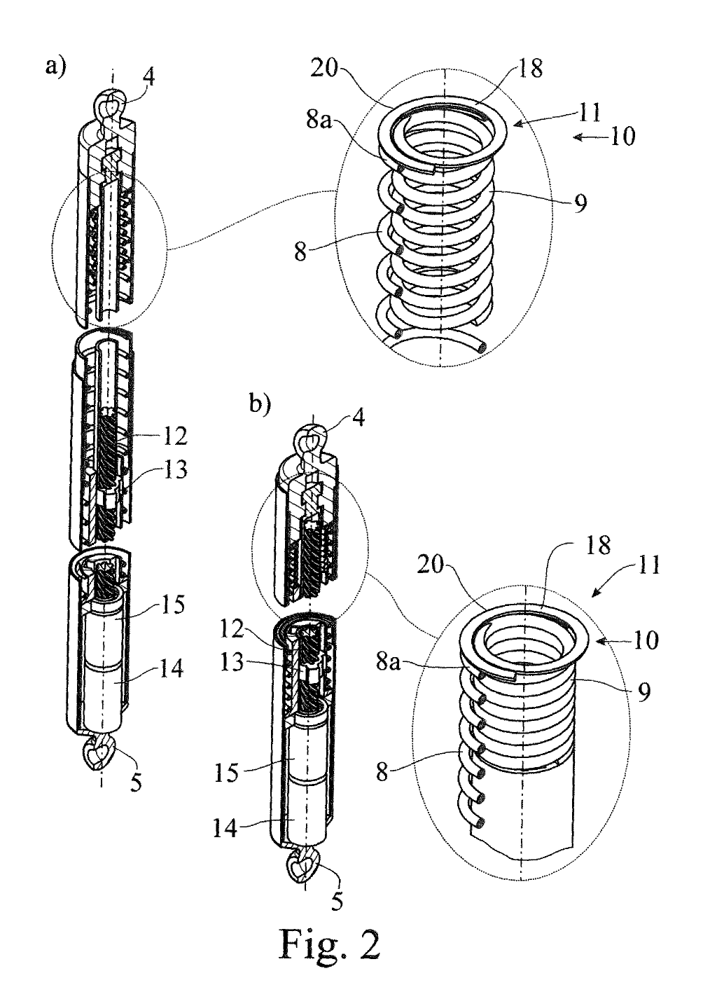

Furthermore, the linear unit 2 has, according to the proposal, a helical spring arrangement 7. The helical spring arrangement 7 has a first spring element 8 which is configured as a helical spring and is made from spring wire, and a second spring element 9 which is configured as a helical spring and is made from spring wire. The two drive connections 4, 5 can be pretensioned against each other by means of the helical spring arrangement 7, as can be gathered from the illustration according to FIG. 2. In some embodiments, as shown in FIG. 2, in the fitted state the second spring element 9 is shorter than the first spring element 8.

With regard to a geometrical spring axis B, the second spring element 9 is oriented coaxially with respect to the first spring element 8 and can be arranged within the first spring element 8. The spring axis B is formed coaxially with respect to the linear axis A here. In order to permit simple installation and to fix the second spring element 9 securely in the linear unit 2, the spring wire at one end 10 of the second spring element 9 forms a supporting portion 11 via which the first spring element 8 secures the second spring element 9 axially with regard to the spring axis B. By this means, during the installation of the linear unit 2, the second spring element 9 can simply be inserted into the first spring element 8 and can be permanently secured axially by the further installation of the linear unit 2. As a result, there is no longer the risk of the second spring element 9 loosening, for example, from a clip connection or the like. Undesirable noises during the opening and/or the closing of the flap 3 due to a second spring element 9 sliding around, because it has been loosened, can be permanently avoided.

Here, the helical spring arrangement 7 pushes the two drive connections 4, 5 apart. The two spring elements 8, 9 can each be designed here as helical compression springs. Here, in the fitted state of the flap arrangement 1, the first spring element 8 pushes the drive connections 4, 5 apart over the entire adjustment range of the flap 3 while, in the fitted state of the flap arrangement 1, the second spring element 9 pushes the drive connections 4, 5 apart only over a partial adjustment range of the flap 3.

In an advantageous manner, the coil of the spiral of the first spring element 8 and the coil of the spiral of the second spring element 9 can be oriented in the same direction, as is shown in the figures. Alternatively, however, they can also be oriented in opposite directions.

In the exemplary embodiment, the gearing 6 is designed as a spindle/spindle-nut gearing. It has a spindle 12 and a nut 13. The spindle/spindle-nut gearing is arranged here within the first spring element 8. It serves for converting drive movements along the linear axis A. Here, the spindle 12 is separated from the spring arrangement by a tube.

According to the configuration of the linear unit 2 that is shown in FIGS. 1 and 2, said linear unit has a motorized drive 14 for producing drive movements along the linear axis A. Here, the drive 14 is arranged at that end of the linear unit 2 which lies opposite the second spring element 9. In order to produce the drive movement, the rotational movement of the motorized drive 14 can be converted into a linear movement by the gearing 6. In this manner, when the linear unit 2 is fitted, the flap arrangement 1 can be adjusted in a motorized manner by means of the linear unit 2. It can be possible to move the flap 3 in a motorized manner with the linear unit 2 or the linear units 2 from a closed position, in particular a preliminary latching closed position, into an, in particular completely opened, open position and/or from an, in particular completely opened, open position into a closed position, in particular into a preliminary latching closed position.

The first spring element 8 can secure the supporting portion 11 of the second spring element 9 in direct contact here.

In the present case, in order to produce the drive movement along the linear axis A, the motorized drive 14 is coupled, optionally via a reduction gearing 15, to the spindle/spindle-nut gearing, in particular to the spindle 12 of the spindle/spindle-nut gearing.

The drive train 16 between the drive connections 4, 5 and the gearing 6 can be not configured to be self-locking. It should be noted here that, in order to form a drive train 16 between the two drive connections 4, 5, the linear unit 2 does not necessarily have to have a motorized drive 14. The force in the drive train 16 for opening the flap 3 can also be provided, for example, solely by the pretensioning of the helical spring arrangement 7.

As can be gathered from the illustration according to FIG. 2, the linear unit 2 can be retracted and extended along the linear axis A. While said linear unit is shown in FIG. 2a in an extended state, it is shown in a retracted state in FIG. 2b. As is furthermore shown in FIG. 2a, here, the first spring element 8 is otherwise in engagement in a force-fitting manner with the linear unit 2 over the entire adjustment range of the linear unit 2.

By contrast, the second spring element 9 is otherwise in engagement in a force-fitting manner with the linear unit 2 only over a partial adjustment range, in particular over a partial adjustment range which is located at one end of the overall adjustment range.

In a configuration, in the fitted state, the second spring element 9 acts with its spring pretensioning on the flap 3, in particular in the opening direction thereof, only over a partial adjustment range of the flap 3, as illustrated in FIG. 2b. Here, said partial adjustment range is limited by the closed position of the flap 3. By this means, the helical spring arrangement 7 can provide a particularly large force in the opening direction of the flap 3 in the region in which the lever ratios for the opening of the flap arrangement 1 are particularly unfavourable. Such a spring element 9 is a pop-up spring, as has been explained further above.

In a further partial adjustment range of the flap 3, the second spring element 9 does not act with spring pretensioning of the flap 3, as emerges from the illustration according to FIG. 2. In said further partial adjustment range, the second spring element 9 is substantially relaxed. Here, said further partial adjustment range of the flap 3 extends over a smaller flap opening angular portion than the partial adjustment range in which the second spring element 9 acts with its spring pretensioning on the flap 3.

As a result of the fact that the second spring element 9 acts only in a partial adjustment range in the linear unit 2, said second spring element is not secured by its pretensioning over the entire adjustment range. Axial securing of said spring element is therefore required so that it can be held over the entire adjustment range. Otherwise, the second spring element 9 could move during the adjustment in the linear unit 2 and produce undesirable noises. In order specifically to avoid this, the clamping according to the proposal is a particularly good structural solution in particular for such a pop-up spring design of the second spring element 9.

The linear unit 2 furthermore has a receiving surface 17 for receiving the spring arrangement 7. Between said receiving surface and the first spring element 8, the supporting portion 11 is secured by axial clamping, as can be gathered from FIGS. 1 and 2. The second spring element 9 can thereby be secured in a particularly simple manner. Here, the receiving surface 17 is provided by a drive connection 4.

The second spring element 9 can have one or more dead windings, in particular in a region on or shortly before the supporting portion 11. This permits centring of the first spring element 8, in particular this permits centring of that end of the first spring element 8 which secures the supporting portion 11. In addition, in particular in order to reduce noise, the first spring element 8 and/or the second spring element 9 can be at least partially flocked. By this means, noises which could arise due to windings of the first spring element 8 and of the second spring element 9 butting against each other or rubbing against each other during the adjustment of the linear unit 2 can be avoided or reduced.

In an open position of the flap 3, that end of the second spring element 9 which faces away from the supporting portion 11 can be free, as illustrated in FIG. 2a. The linear unit 2 can have an, in particular L-shaped, supporting element 19, onto which that end of the second spring element 9 which faces away from the supporting portion 11 runs and against which the second spring element 9 is braced when the flap 3 is moved into a closed position. As shown in FIG. 1, in the fitted state of the linear unit 2, the first spring element 8 can be supported with its end facing away from the supporting portion 11 on the supporting element 19. The first spring element 8 and the second spring element 9 can be supported on different surfaces of the supporting element 19, said surfaces here being arranged offset in the direction of the linear axis A.

In order to form a supporting surface 18, the supporting portion 11 can be ground at the second spring element 9. This increases the contact surface between the receiving surface 17 and the supporting surface 18. Additionally or alternatively, that surface of the first spring element 8 which faces the receiving surface 17 can also be ground in order to form a supporting surface 8a. This also increases the abutment surface and achieves better contact between first spring element 8 and the supporting portion 11, and therefore a more stable securing thereof.

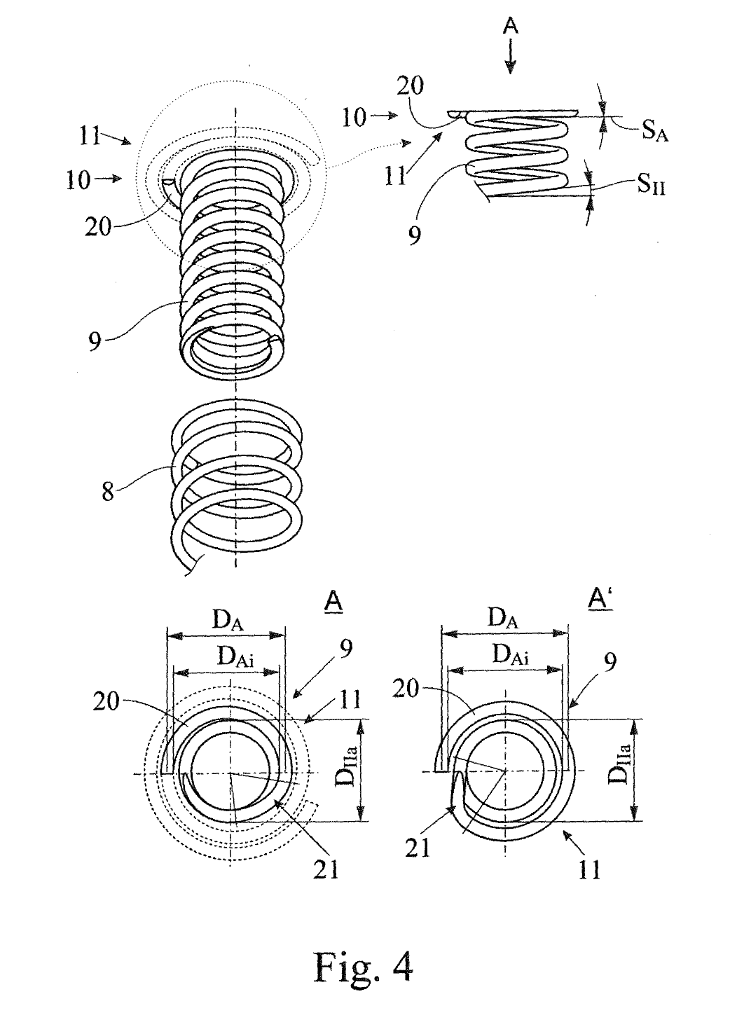

As can be gathered from the illustration according to FIG. 2, the supporting portion 11 has a supporting winding 20 which is secured by axial clamping between the first spring element 8 and the receiving surface 17. The supporting winding 20 can have a helical or spiral or circular-section profile. The supporting portion 11, in particular the supporting winding 20, can extend over an angular range of at least 60°, such as at least 90°, furthermore such as at least 180°, furthermore such as at least 270°, with regard to the spring axis B. The term “supporting winding” should therefore be broadly understood as meaning that the supporting winding 20 does not have to completely encircle the spring axis B. However, as indicated by dashed lines in FIG. 4, the supporting winding 20 can also extend with regard to the spring axis B over an angular portion of more than 360°, in particular if said supporting winding is of spiral design.

Furthermore, the supporting portion 11, in particular if it has a circular-section profile, can have a transition portion 21 via which the winding diameter of the second spring element 9 is increased in order to form the supporting winding 20. It should furthermore be pointed out that the supporting winding 20 can have a plurality of portions, wherein the supporting winding portions can have a profile of differing shape. For example, one supporting winding portion can have a helical profile while a further supporting winding portion can have a spiral profile. Furthermore, the supporting winding portions can also have other combinations of profiles. The supporting winding portions together can form a combination of a helical and/or spiral and/or circular-section profile.

Here, the central winding diameter DA of the supporting winding 20 of the second spring element 9 is larger than the outer winding diameter D_{IIa} of the second spring element 9 otherwise. In the exemplary embodiment and furthermore, the inner winding diameter D_{Ai} of the supporting winding 20 of the second spring element 9 can be larger than the outer winding diameter D_{IIa} of the second spring element 9 otherwise. In this case, the transition portion from the rest of the second spring element 9 is not included.

Furthermore, the central winding diameter DA of the supporting winding 20 substantially corresponds over a substantial portion to the central winding diameter Di of the first spring element 8. By this means, a particularly stable abutment can be formed for the first spring element 8 in order to secure the second spring element 9.

As shown in FIG. 4, in the untensioned state of the second spring element 9, the winding pitch SA of the supporting portion 11, in particular of the supporting winding 20, here is lower than the winding pitch S_{II} of the second spring element 9 otherwise. In the untensioned state of the second spring element 9, the winding pitch of the supporting portion 11 here is smaller than 10°, furthermore smaller than 5°. In a configuration, the winding pitch of the supporting portion 11 can be substantially 0°. Here, the winding pitch is defined as the pitch of the spiral of the second spring element 9 with respect to a plane orthogonal to the spring axis B.

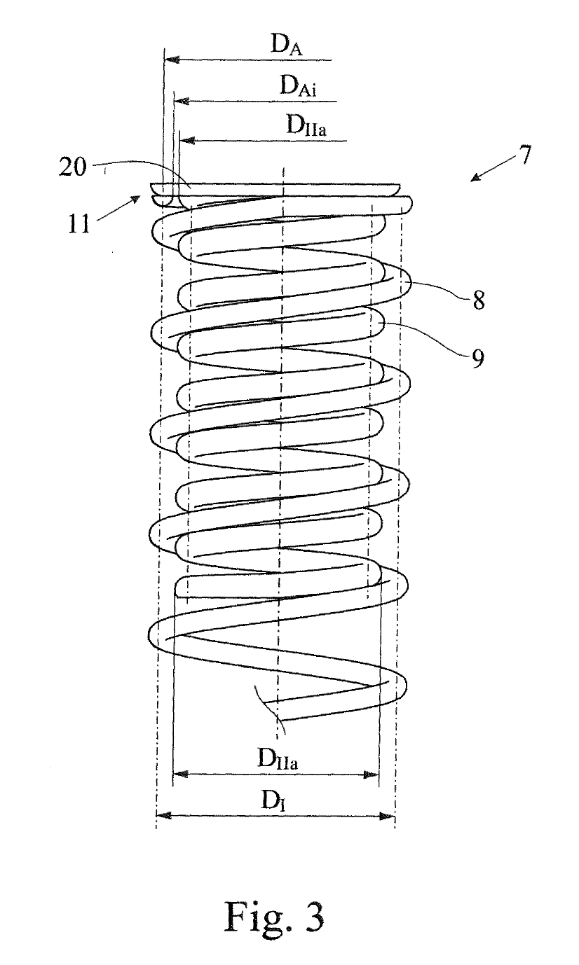

In order to further improve the securing of the supporting portion 11, for the axial securing, the first spring element 8 acts on the supporting portion 11, in particular the supporting winding 20, over an angular range of at least 60°, or at least 90°, with regard to the spring axis B. In order to achieve a particularly stable securing of the second spring element 9 and also to particularly effectively counteract tilting tendencies of the second spring element 9, it is possible, as in the exemplary embodiment, in particular shown in FIGS. 2 and 3, for the axial securing, for the first spring element 8 to act on the supporting portion, in particular the supporting winding, over an angular range of at least 180°, or furthermore at least 270°, with regard to the spring axis B. In the event of securing over 270°, a particularly stable supporting and securing of the second spring element 9 is achieved in all directions of inclination.

A centring element, in particular made from plastic, can be provided on the supporting portion 11, in particular on the supporting winding 20. Said centring element can centre the first spring element 8 and/or the second spring element 9, in particular at one of the ends thereof. Additionally or alternatively, a buffer element, can be made from plastic, can be provided on the supporting portion 11, in particular the supporting winding 20, said buffer element reducing the pressing of the supporting portion by the first spring element 8. Particularly, the centring element and the buffer element are formed integrally.

Finally, it should be pointed out that the linear unit 2 can have an, in particular telescopic, housing 22 for protecting said linear unit from environmental influences. The drive connections 4, 5 can form a cover of said housing 22, as a result of which particularly simple installation is ensured.

1. A linear unit for a flap arrangement with a flap which is adjustable between an open position and a closed position, wherein the linear unit has two drive connections which are coupled to each other via a gearing and are adjustable relative to each other along a geometrical linear axis,
wherein the linear unit has a helical spring arrangement, wherein the helical spring arrangement has a first spring element which is configured as a helical spring and is made from spring wire and a second spring element which is configured as a helical spring and is made from spring wire, with which helical springs the two drive connections can be pretensioned against each other, wherein the second spring element is oriented coaxially with respect to the first spring element with regard to a geometrical spring axis,
wherein the spring wire at one end of the second spring element forms a supporting portion via which the first spring element secures the second spring element axially with regard to the spring axis.

2. The linear unit according to claim 1, wherein the second spring element is arranged within the first spring element.

3. The linear unit according to claim 1, wherein the helical spring arrangement pushes the two drive connections apart, and/or wherein the two spring elements are each configured as helical compression springs.

4. The linear unit according to claim 1, wherein the gearing has a spindle/spindle-nut gearing.

5. The linear unit according to claim 1, wherein the linear unit has a motorized drive for producing drive movements along the linear axis, and wherein, when the linear unit is fitted, the flap arrangement is adjustable in a motorized manner by the linear unit.

6. The linear unit according to claim 1, wherein the drive train between the drive connections and the gearing is not configured to be self-locking.

7. The linear unit according to claim 1, wherein the first spring element is otherwise in engagement in a force-fitting manner with the linear unit over the entire adjustment range of the linear unit, and wherein the second spring element is otherwise in engagement in a force-fitting manner with the linear unit only over a partial adjustment range.

8. The linear unit according to claim 1, one of the preceding claims, wherein, in the fitted state, the second spring element acts with its spring pretensioning on the flap only over a partial adjustment range of the flap.

9. The linear unit according to claim 1, wherein, in the fitted state, the second spring element is shorter than the first spring element.

10. The linear unit according to claim 1, wherein the linear unit has a receiving surface for receiving the spring arrangement, and wherein the supporting portion is secured by axial clamping between the first spring element and the receiving surface.

11. The linear unit according to claim 1, wherein the supporting portion has at least one portion of a supporting winding which is secured by axial clamping between the first spring element and the receiving surface.

12. The linear unit according to claim 1, wherein the winding pitch of the supporting portion is lower than the winding pitch of the second spring element.

13. The linear unit according to claim 1, wherein the supporting portion extends with regard to the spring axis over an angular range of at least 60°.

14. The linear unit according to claim 1, wherein the central winding diameter of the supporting winding of the second spring element is greater than the outer winding diameter of the second spring element otherwise, wherein the inner winding diameter of the supporting winding of the second spring element is greater than the outer winding diameter of the second spring element otherwise.

15. The linear unit according to claim 1, wherein, for the axial securing, the first spring element acts on the supporting portion over an angular range of at least 60° with regard to the spring axis.

16. A flap arrangement with a flap which is adjustable between an open position and a closed position, and with a linear unit according to claim 1 which is coupled to the flap in terms of drive.

17. The linear unit according to claim 4, wherein the spindle/spindle-nut gearing is arranged within the first spring element.

18. The linear unit according to claim 8, wherein, in the fitted state, the second spring element acts with its spring pretensioning on the flap only over a partial adjustment range of the flap, which partial adjustment range is limited by the closed position of the flap.

19. The linear unit according to claim 11, wherein the supporting winding has a helical or spiral or circular-section profile.

20. The linear unit according to claim 12, wherein the winding pitch of the supporting element is smaller than 10°.
